(19) United States
(12) Patent Application Publication
(10) Pub. No.: US 2007/0075814 A1
(43) Pub. Date: Apr. 5, 2007

(54) Ignition coil for an internal combustion engine

(76) Inventors: Konstantin Lindenthal, Blaichach (DE); Nikolaus Hautmann, Weitnau (DE); Markus Knepper, Waltenhofen/Oberdorf (DE)

Correspondence Address: KENYON & KENYON LLP, ONE BROADWAY, NEW YORK, NY, 10004, US

(21) Appl. No.: 11/520,475

(22) Filed: Sep. 12, 2006

(30) Foreign Application Priority Data
Sep. 30, 2005 (DE) 10 2005 047 184.6

(51) Int. Cl. H01F 27/02

(52) U.S. Cl. 336/90

(57) ABSTRACT

An ignition coil for an internal combustion engine has a secondary coil shell and a primary coil shell, which are positioned concentrically about a core and produced from plastic by injection molding methods. To avoid damage to the wire, at least the secondary coil shell is configured in such a way that it has no mold offset and no burrs in its winding region for the wire, which is achieved by providing separation planes extending transversely to the longitudinal axis.

### FIELD OF THE INVENTION

The present invention relates to an ignition coil for an internal combustion engine having a magnetically active core.

### BACKGROUND INFORMATION

An ignition coil having a magnetically active core is described, e.g., in published European Patent 859 383, which ignition coil has a primary and a secondary coil shell onto which a wire is wound in each case. To delimit the winding space for the wire, the cylindrical primary and secondary coil shells each have circumferential segments or chamber delimitation walls, which are situated transversely to the longitudinal extension of the coil shell. Due to these segments or chamber delimitation walls and due to the coil shells being produced by injection-molding methods, the coil shells have a separation plane that extends in the longitudinal direction of the coil shells. This design of the coil shells, which includes longitudinally extending separation planes, is attributable to the fact that the two circumferential segments or chamber delimitation walls allow an ejection of the coil shells from the injection molding die only transversely to the longitudinal direction of the coil shells, which means a mold offset and injection burrs result along the separation plane of the coil shells. In the worst case, the mold offset and the injection burrs can cause the wire to rupture during the winding operation. Furthermore, the enamel insulation of the wire may be damaged when winding across the burr. Since the burr or mold offset usually extends across the entire winding space, the mentioned risk of wire rupture or wire damage exists for a relatively large lengthwise portion of the wire.

Furthermore, in particular due to the mold offset, it is possible that the winding structure is adversely affected, i.e., adversely affect the correct position and the correct tension for winding the wire. Overall, there is thus the potential of lower product quality of the injection coil.

### SUMMARY OF THE INVENTION

The ignition coil for an internal combustion engine according to the present invention provides the advantage of eliminating mold offsets and injection burrs in the winding region of the coil shells, thus avoiding the risk of damage to the wire and ensuring optimal wire structure. This results in an especially high product quality. According to the present invention, this is achieved by the coil shell having a separation plane that extends transversely to its longitudinal axis. When winding the wire onto the coil shell, it is therefore no longer necessary to guide the coil wire across an injection burr or a mold offset. Furthermore, forming the coil shell with a separation plane that extends transversely to the longitudinal direction allows an especially optimal and uncomplicated plastic-appropriate design of the coil shell with uniform wall thicknesses.

In order to delimit the winding space from a wire-contacting region, a separation segment is provided, which may have a recess so as to guide the coil wire from the winding space into the wire-contacting space.

In order to prevent the coil wire from sliding off the winding region and into the interference-suppression region, an example embodiment of the present invention provides a guide for the wire on the coil shell in the transition region between the two regions.

It may be provided that both the secondary coil shell and the primary coil shell are designed in such a way that no separation plane is formed in the respective winding region on the coil shell.

### BRIEF DESCRIPTION OF THE DRAWINGS

FIG. 1 shows a longitudinal cross-sectional view through an ignition coil according to the present invention.

FIG. 2 shows a side view of a secondary coil shell.

FIG. 3 shows a view taken along the plane III-III indicated on FIG. 2.

FIGS. 4 to 6 show side views of three different exemplary embodiments of the secondary coil shells.

FIG. 7 shows a cross-sectional view of the secondary coil shell taken along the plane VII-VII indicated on FIG. 6.

FIGS. 8 and 9 show detail views of two different exemplary embodiments of the secondary coil shell.

FIG. 10 shows a plan view of another exemplary embodiment of the secondary coil shell.

FIG. 11 shows a side view of another exemplary embodiment of the secondary coil shell.

### DETAILED DESCRIPTION

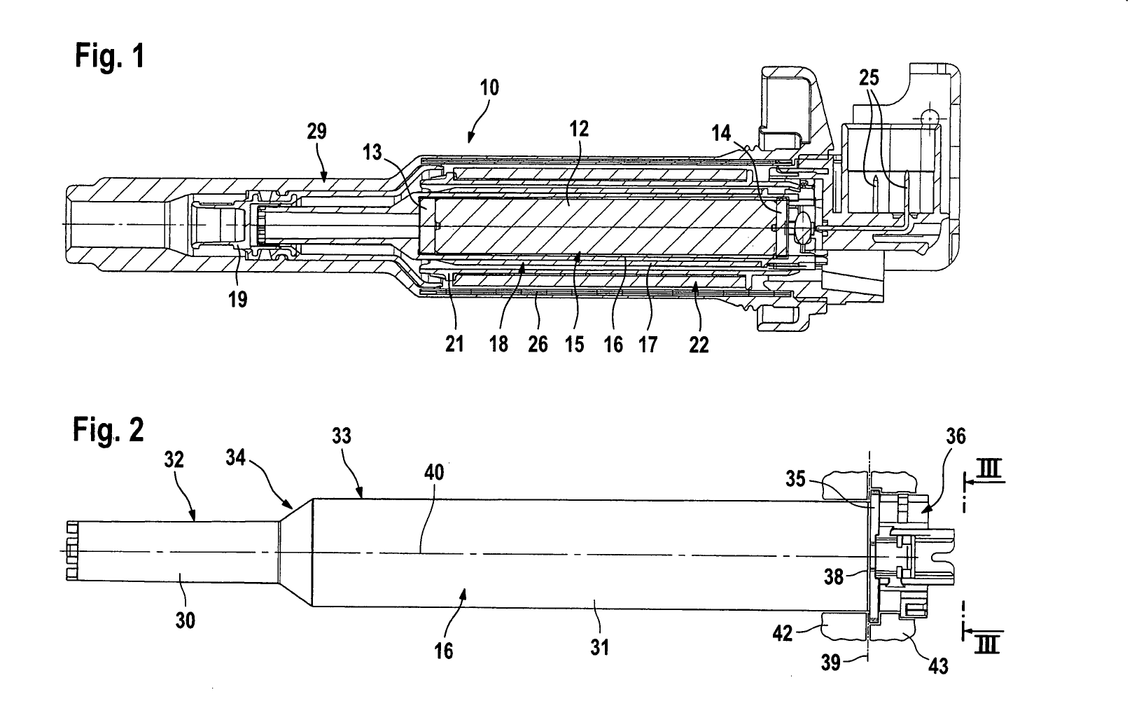

Ignition coil 10 shown in FIG. 1 is designed as a so-called rod-type ignition coil and used for the direct contacting of a spark plug (not shown further) of an internal combustion engine. Ignition coil 10 has a magnetically active core 12, which has a rod-type design and is provided with a permanent magnet 13 and a damping element 14, respectively, on its end faces lying opposite each other. Core module 15, which is made up of core 12, permanent magnet 13 and damping element 14 and is optionally enclosed by a shrink tube, is situated within an essentially sleeve-shaped secondary coil shell 16. A wire 17, which forms a so-called secondary winding 18 contacted by a connection element 19 via one end, is wound onto secondary coil shell 16, connection element 19 in turn being connectable to the head region of the spark plug for electrical contacting.

The high voltage-carrying secondary winding 18 is concentrically surrounded by a primary coil shell 21 onto which a wire is wound, which forms a so-called primary winding 22. The primary winding is contacted by an electronic circuit, which is coupled to the on-board voltage of the motor vehicle via connector plugs 25. Primary coil shell 21 and primary winding 22 are enclosed by a sleeve-type magnetic yoke element 26, which closes the magnetic circuit and has a longitudinally slotted design in order to avoid magnetic short circuits.

The components of ignition coil 10 described so far are situated inside an ignition coil housing 29, which defines the outer form of ignition coil 10, the interspaces between the components of ignition coil 10 being filled with an insulating resin mass.

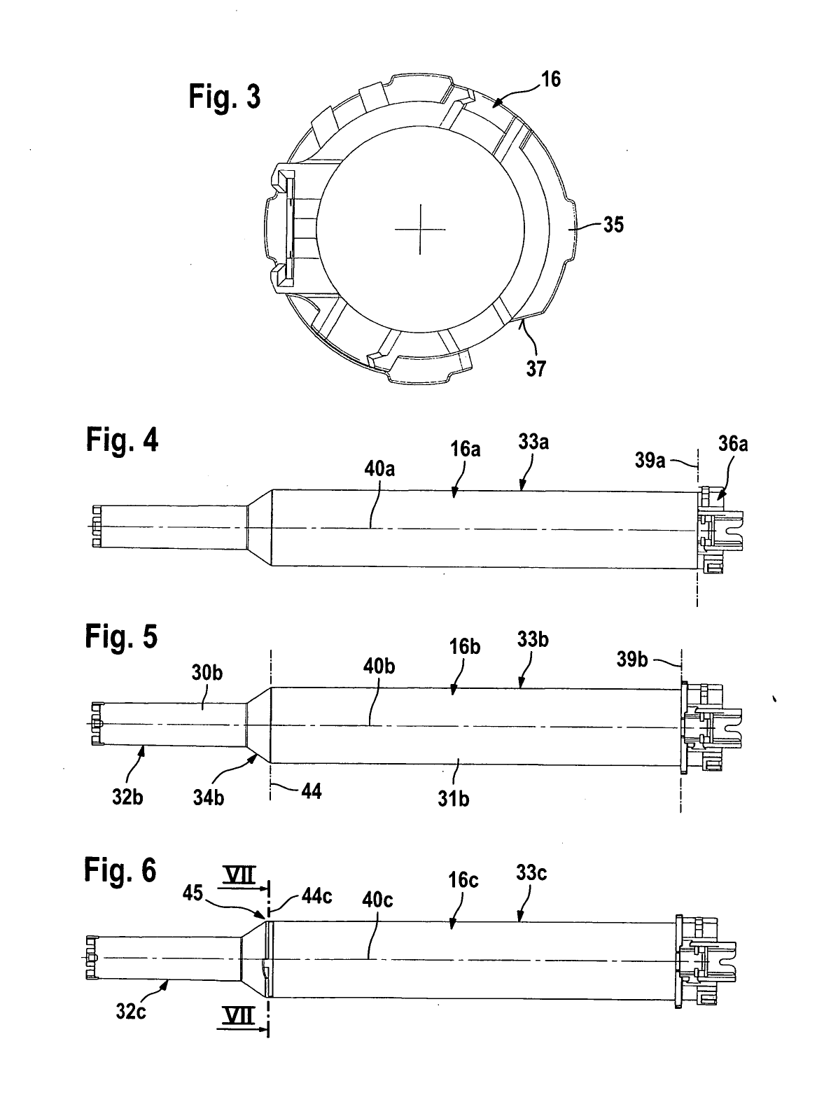

With reference to FIGS. 2 and 3, the configuration according to the present invention, in particular the design of the coil shells essential to the present invention, will now be elucidated in greater detail by way of example using secondary coil shell 16 as example. In the first exemplary embodiment, secondary coil shell 16 according to the present invention has two hollow-cylindrical sections 32, 33, section 32 having a smaller (outer) diameter than section 33. The two sections 32, 33 are interconnected via a frustoconical connection section 34. Wound onto section 33 is wire 17 (not shown in FIGS. 2 and 3) of secondary winding 18, which is guided across connection section 34 and section 32 to connection element 19 in order to allow contacting of the spark plug. In section 32, which forms a so-called interference-suppressing winding region 30, wire 17 is usually wound in only a single layer or otherwise only a few wire layers, whereas wire 17 is wound in a multitude of superposed layers in so-called transformer winding region 31 in section 33.

On the end of section 33 lying opposite section 32, the secondary coil shell has a flange-type, circumferential delimitation (or separation) segment 35 and a wire contacting region 36. Delimitation segment 35 delimits transformer winding region 31 for secondary winding 18 and has at least one recess 37 or feed-through for wire 17 of secondary winding 18 in order to couple it to a current bar, e.g., in wire contacting region 36.

Furthermore, a separation seam 38, which extends transversely to longitudinal axis 40 of secondary coil shell 16 and runs in a separation plane 39, can be seen between section 33 and delimitation segment 35 in FIG. 2. Two injection molding dies 42, 43 directly abut each other in separation plane 39 in order to produce secondary coil shell 16; each is displaceable parallel to longitudinal axis 40 for ejection of secondary coil shell 16. It is essential in this context that injection molding die 42 used to mold sections 32, 33 of secondary coil shell 16 has no separation plane parallel to longitudinal axis 40. Instead of a one-part injection molding die 43, which essentially is used to-form wire contacting region 36, it is also possible to design injection molding die 43 in such a way that it is additionally able to be split longitudinally, i.e., perpendicular to separation plane 39. The (additional) separation plane of injection molding die 43 may be positioned in such a manner that wire 17 of secondary winding 18 guided into wire contacting region 36 is not led across this additional separation plane, so that damage to wire 17 is prevented. As an alternative, it is also conceivable to prevent direct contacting of wire 17 of secondary winding 18 by a corresponding design of wire contacting region 36 or by ramps or the like, with the aid of an additional separation plane of injection molding die 43. Contacting of wire 17 in separation plane 39 may likewise be avoided by appropriate design of secondary coil shell 16 in the region of the at least one recess 37.

Overall, secondary coil shell 16 has no production-related burrs, neither in transformer winding region 31 nor in interference-suppressing winding region 30, which could cause damage to wire 17 or which otherwise might cause a disadvantageous winding configuration.

In the exemplary embodiment according to FIG. 4, in contrast to secondary coil shell 16 shown in FIG. 2, secondary coil shell 16a has no delimitation segment between section 33a and wire contacting region 36a. Separation plane 39a situated perpendicular to longitudinal axis 40a extends directly along the boundary between section 33a and wire contacting region 36a.

The exemplary embodiment according to FIG. 5 differs from the first exemplary embodiment according to FIGS. 2 and 3 in that, in addition to separation plane 39b, secondary coil shell 16b has at least one further separation plane 44, both separation planes 39b, 44 being situated parallel to each other. As illustrated, additional separation plane 44 may be located between connection section 34b and section 33b, or otherwise between connection section 34b and section 32b. Due to additional separation plane 44, section 32b of secondary coil shell 16b, i.e., interference-suppression winding region 30b, is able to be produced and unmolded with the aid of form tools that are displaceable transversely to longitudinal axis 40b, with separation planes correspondingly situated transversely to longitudinal axis 40b. In this example as well, at least transformer winding region 31b of secondary coil shell 16b is free of burrs for wire 17 of secondary winding 18.

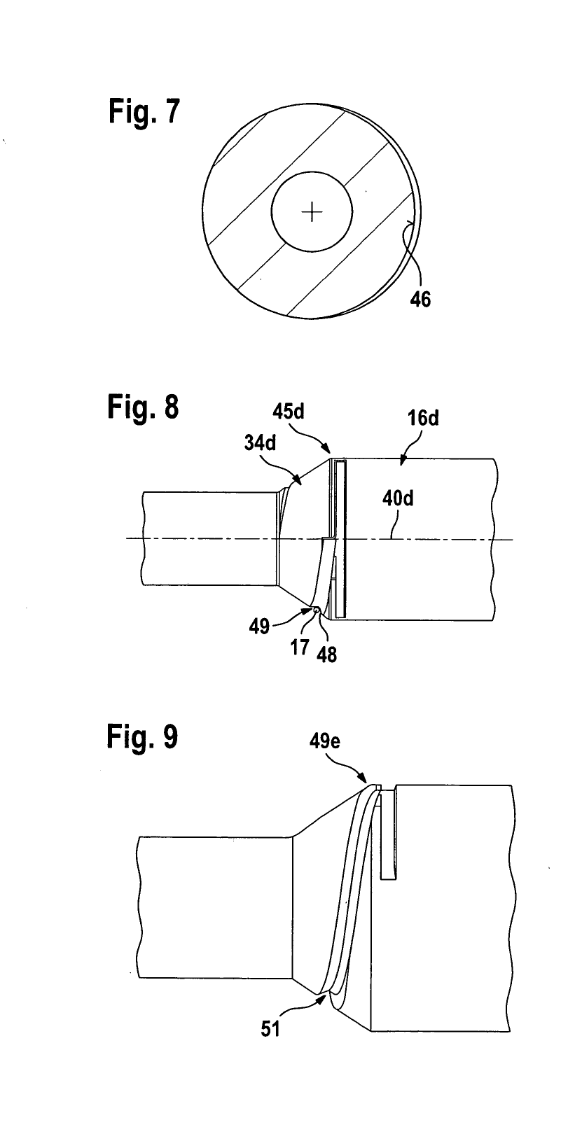

The exemplary embodiment according to FIGS. 6 and 7 differs from the exemplary embodiment according to FIG. 5 in that additional separation plane 44c of secondary coil shell 16c projects into section 33c by a slight amount. In this region 45 of transformer winding region 31, an eccentrically positioned groove 46 (FIG. 7) is formed in the surface of secondary coil shell 16c, which extends across maximally 180° of the winding diameter of wire 17 of secondary winding 18. Only the one layer of wire 17 or secondary winding 18 that is guided across connection section 34c into section 32c is situated in this groove 46.

The form of groove 46 and the guidance of wire 17 defined thereby prevent wire 17 from sliding off section 33c and into connection section 34c. Additional separation plane 44c is required to produce groove 46 to allow form tools that are moveable transversely to longitudinal axis 40c to be placed on the side of separation plane 44c facing section 32c.

In the exemplary embodiment according to FIG. 8, in contrast to the exemplary embodiment according to FIGS. 6 and 7, an additional separation plane transverse to longitudinal axis 40d of secondary coil shell 16d in region 45d is eliminated in order to allow ejection of secondary coil shell 16d in the direction of longitudinal axis 40d. To achieve defined guidance of wire 17, a guideway 49, which has a step 48 and is situated in connection section 34d in the form of a spiral, is formed in connection section 34d. The number of helical coils or the incline of guideway 49 may differ according to the application.

In the embodiment according to FIG. 9, guideway 49e on secondary coil shell 16e is additionally provided with an undercut 51, which allows especially safe guidance of wire 17.

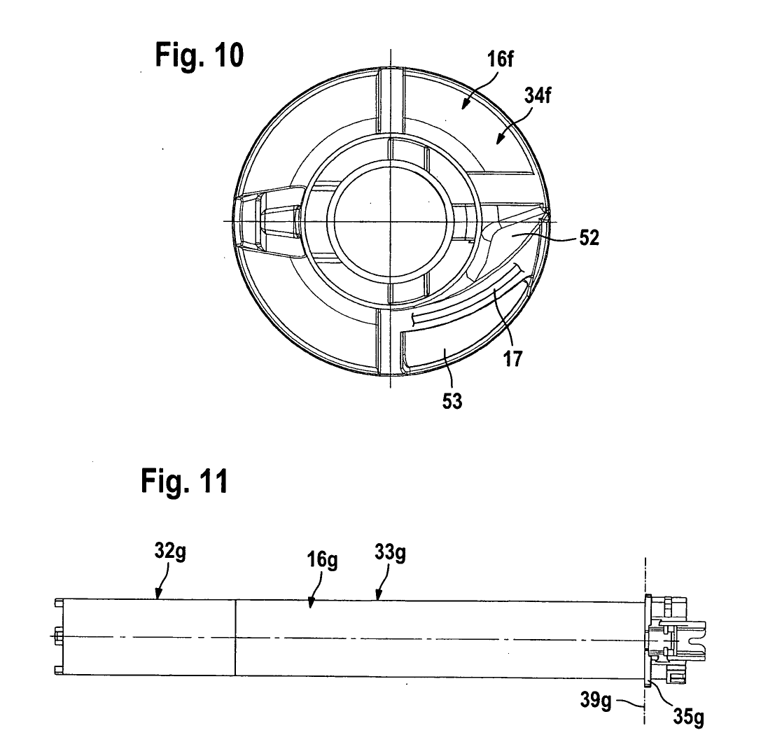

The exemplary embodiment according to FIG. 10 shows a guideway for wire 17 in connection section 34f, which is made up of guide ribs 52, 53 premolded in connection section 34f. Such a secondary coil shell 16f also can dispense with additional separation planes placed transversely to the longitudinal axis of secondary coil shell 16f, so that ejection in the longitudinal direction of secondary coil shell 16f is possible.

Finally, FIG. 11 shows an example embodiment in which a secondary coil shell 16g whose section 32g has the same diameter as section 33g. There is only one separation plane 39g in the region of delimitation segment 35g.

Overall, all secondary coil shells according to the present invention provide an exceptionally high product quality by dispensing with separation planes that extend perpendicular to longitudinal axis 40, at least in transformer winding region 31, which in turn prevents damage to wire 17 of secondary winding 18 and a disadvantageous winding setup.

Additionally, it should be noted that secondary coil shell lends itself to a design according to the present invention due to the considerably smaller diameter of wire 17 of secondary winding 18 compared to the wire of primary winding 22. However, to increase the product quality even further, it is possible to apply the above-noted configurations of the secondary coil shell to primary coil shell 22 as well.

What is claimed is:

1. An ignition coil unit for an internal combustion engine, comprising:
a magnetically active core;
a secondary coil;
a primary coil; and
a substantially cylindrical secondary coil shell for at least the secondary coil, wherein the secondary coil shell is made of plastic and produced by an injection molding, and wherein the secondary coil shell includes a winding region in which a plurality of layers of a wire are wound, and wherein, at least in the winding region, the secondary coil shell is configured without separation planes in a longitudinal direction of the secondary coil shell.

2. The ignition coil unit as recited in claim 1, wherein the secondary coil shell has a wire contacting region which abuts the winding region in the longitudinal direction, and wherein the secondary coil shell has a first separation plane which extends transversely to the longitudinal direction and is situated between the winding region and the wire contacting region, and wherein the first separation plane is provided for ejection of the secondary coil shell.

3. The ignition coil unit as recited in claim 2, wherein the secondary coil shell has a flange-type separation segment which extends transversely to the longitudinal direction and separates the winding region from the wire contacting region, and wherein the flange-type separation segment is disposed between the winding region and the wire contacting region, and wherein the separation segment has a feed-through recess for channeling the wire from the winding region into the wire contacting region.

4. The ignition coil unit as recited in claim 2, wherein, on the side of the winding region positioned opposite the wire contacting region, an interference-suppressing winding region is disposed, and wherein the wire has a smaller number of superposed layers in the interference-suppressing winding region than in the winding region.

5. The ignition coil unit as recited in claim 4, wherein the secondary coil shell has a smaller outer diameter in the interference-suppressing winding region than in the winding region.

6. The ignition coil unit as recited in claim 5, wherein the winding region and the interference-suppressing winding region are interconnected via a frustoconical transition region.

7. The ignition coil unit as recited in claim 5, wherein a second separation plane is formed on the secondary coil shell between the winding region and the interference-suppressing winding region, and wherein the first and the second separation planes are situated parallel to each other.

8. The ignition coil unit as recited in claim 6, wherein a guide arrangement for the wire is provided in the frustoconical transition region.

9. The ignition coil unit as recited in claim 6, wherein a guide for the wire is formed in the secondary coil shell in the winding region, directly adjacent to the transition region, and wherein a smaller number of layers of the wire is provided in the region of the guide in comparison to the winding region.

10. The ignition coil unit as recited in claim 1, further comprising:
a primary coil shell for the primary coil, wherein the primary coil shell includes a winding region in which a plurality of layers of the wire are wound, and wherein both the primary coil shell and the secondary coil shell lack a separation plane in the respective winding regions.

11. The ignition coil unit as recited in claim 3, wherein, on the side of the winding region positioned opposite the wire contacting region, an interference-suppressing winding region is disposed, and wherein the wire has a smaller number of superposed layers in the interference-suppressing winding region than in the winding region.

12. The ignition coil unit as recited in claim 11, wherein the secondary coil shell has a smaller outer diameter in the interference-suppressing winding region than in the winding region.

13. The ignition coil unit as recited in claim 6, wherein a second separation plane is formed on the secondary coil shell between the winding region and the interference-suppressing winding region, and wherein the first and the second separation planes are situated parallel to each other.

14. The ignition coil unit as recited in claim 13, wherein a guide arrangement for the wire is provided in the frustoconical transition region.

15. The ignition coil unit as recited in claim 7, wherein a guide for the wire is formed in the secondary coil shell in the winding region, directly adjacent to the transition region, and wherein a smaller number of layers of the wire is provided in the region of the guide in comparison to the winding region.

16. The ignition coil unit as recited in claim 2, further comprising:
a primary coil shell for the primary coil, wherein the primary coil shell includes a winding region in which a plurality of layers of the wire are wound, and wherein both the primary coil shell and the secondary coil shell lack a separation plane in the respective winding regions.

17. The ignition coil unit as recited in claim 3, further comprising:
a primary coil shell for the primary coil, wherein the primary coil shell includes a winding region in which a plurality of layers of the wire are wound, and wherein both the primary coil shell and the secondary coil shell lack a separation plane in the respective winding regions.

18. The ignition coil unit as recited in claim 4, further comprising:
a primary coil shell for the primary coil, wherein the primary coil shell includes a winding region in which a plurality of layers of the wire are wound, and wherein both the primary coil shell and the secondary coil shell lack a separation plane in the respective winding regions.
